(19) United States
(12) Patent Application Publication
(10) Pub. No.: US 2023/0289620 A1
(43) Pub. Date: Sep. 14, 2023

(54) IMPUTING COUNTERFACTUAL DATA TO FACILTIATE MACHINE LEARNING MODEL TRAINING

(71) Applicant: INTERNATIONAL BUSINESS MACHINES CORPORATION, Armonk, NY (US)

(72) Inventors: Ruijiang GAO, Austin, TX (US); Wei SUN, Scarsdale, NY (US); Max BIGGS, Charlottesville, VA (US); Youssef DRISSI, Peekskill, NY (US); Markus ETTL, Yorktown Heights, NY (US)

(21) Appl. No.: 17/654,617

(22) Filed: Mar. 14, 2022

(51) Int. Cl. G06N 5/02; G06N 5/04

(52) U.S. Cl. CPC G06N 5/022; G06N 5/04

(57) ABSTRACT

One or more application domain properties are integrated into a machine learning model by obtaining training data for use in training the machine learning model, where the training data includes factual data relating to a particular application, and obtaining, with reference to the training data, unlabeled counterfactual data for the particular application. The method includes imputing one or more labels to the unlabeled counterfactual data using domain knowledge for the particular application to obtain imputed counterfactual data. The domain knowledge includes one or more application domain properties. Further, the method includes training the machine learning model using the training data and the imputed counterfactual data to facilitate generating machine learning model predictions for the particular application in accordance with the one or more application domain properties.

### BACKGROUND

Machine learning (ML) provides computers with an ability to learn, or continue learning, without being pre-programmed. Machine learning utilizes algorithms that learn from data and create insights based on the data, such as making predictions or decisions.

Training data in machine learning is the data used to train a model to make a prediction and solve a problem, provide relevant recommendations, perform an action, etc. Supervised learning refers to the task of inducing a learning function from a set of labeled data examples so the function can map between the input (input variable(s)) and the output (output variable(s)) in the training examples. After training, the created model should be able to generalize and correctly predict output(s) for unseen datapoints.

### SUMMARY

Certain shortcomings of the prior art are overcome and additional advantages are provided through the provision, in one or more aspects, of a computer program product for facilitating processing within a computing environment. The computer program product includes one or more computer-readable storage media and program instructions embodied therewith. The program instructions are readable by a processing circuit to cause the processing circuit to perform a method. The method includes obtaining training data for use in training a machine learning model, where the training data includes factual data relating to a particular application, and obtaining with reference to the training data, unlabeled counterfactual data for the particular application. Further, the method includes imputing one or more labels to the unlabeled counterfactual data, using domain knowledge for the particular application, to obtain imputed counterfactual data. The domain knowledge includes one or more application domain properties. Further, the method includes training the machine learning model using the training data and the imputed counterfactual data to facilitate generating machine learning model predictions for the particular application in accordance with the one or more application domain properties.

Computer systems and computer-implemented methods relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one embodiment of a system, illustrating certain aspects of an embodiment of the present invention;

FIG. 2 illustrates various aspects of machine learning in accordance with some embodiments of the present invention;

FIG. 3 depicts one embodiment for updating a machine learning model, including iteratively training on both factual data and imputed counterfactual data, in accordance with one or more aspects of the present invention;

FIG. 4 depicts one embodiment of a workflow illustrating certain aspects of one or more embodiments of the present invention;

FIG. 5 illustrates another embodiment of a workflow illustrating certain aspects of one or more embodiments of the present invention;

FIG. 6A graphically illustrates one embodiment of model results using machine learning model training on factual data alone;

FIG. 6B illustrates updated model results after, for instance, a first imputation of labels for counterfactual data, and use of the imputed counterfactual data in training the machine learning model, in accordance with one or more aspects of the present invention;

FIG. 6C illustrates further updated model results upon convergence using imputed counterfactual data, in accordance with one or more aspects of the present invention;

FIGS. 7A-7B depict a further embodiment of a workflow illustrating certain aspects of one or more embodiments of the present invention;

FIG. 8 depicts one example of a computing environment to incorporate and use one or more aspects of the present invention;

FIG. 9A depicts another example of a computing environment to incorporate and use one or more aspects of the present invention;

FIG. 9B depicts one example of further details of a memory of FIG. 9A, in accordance with one or more aspects of the present invention;

FIG. 10 depicts another example of a cloud computing environment, in accordance with one or more aspects of the present invention; and

FIG. 11 depicts one example of abstraction model layers, in accordance with one or more aspects of the present invention.

### DETAILED DESCRIPTION

The accompanying figures, which are incorporated in and form a part of this specification, further illustrate the present invention and, together with this detailed description of the invention, serve to explain aspects of the present invention. Note in this regard that descriptions of well-known systems, devices, processing techniques, etc., are omitted so as to not unnecessarily obscure the invention in detail. It should be understood, however, that the detailed description and this specific example(s), while indicating aspects of the invention, are given by way of illustration only, and not limitation. Various substitutions, modifications, additions, and/or other arrangements, within the spirit or scope of the underlying inventive concepts will be apparent to those skilled in the art from this disclosure. Note further that numerous inventive aspects or features are disclosed herein, and unless inconsistent, each disclosed aspect or feature is combinable with any other disclosed aspect or feature as desired for a particular application of the concepts disclosed herein.

Note also that illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

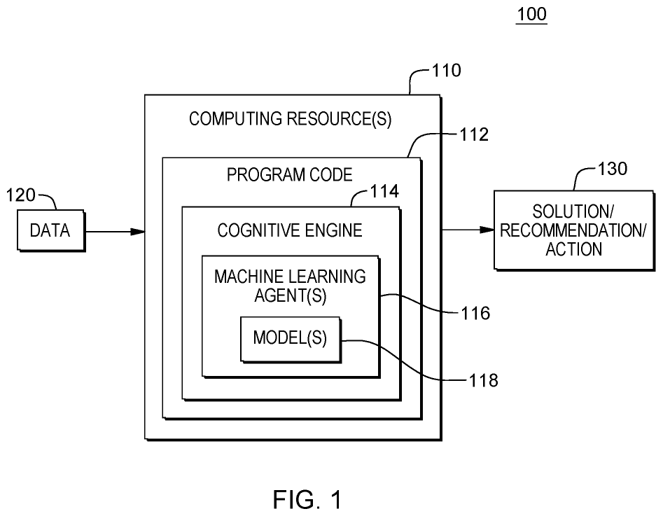

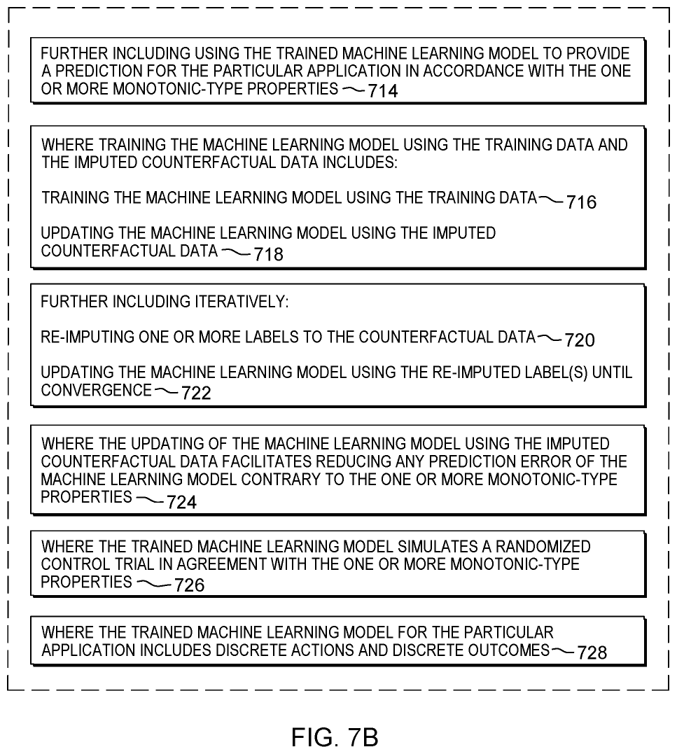

As understood by one skilled in the art, program code, as referred to in this application, can include both software and hardware. For example, program code in certain embodiments of the present invention can utilize a software-based implementation of the functions described, while other embodiments can include fixed function hardware. Certain embodiments combine both types of program code. Examples of program code, also referred to as one or more programs, are depicted in FIG. 1 as program code 112, and in FIG. 8 as application program(s) 816, computer-readable program instruction(s) 820, machine learning agent(s) 822, and machine learning model(s) 821, which are stored in memory 806, by way of example only.

As noted, machine learning provides computers with the ability to continually learn without being preprogrammed. Machine learning utilizes algorithms that learn from data and create insights based on the data, such as provide relevant recommendations, solve problems, perform actions, etc. A machine learning algorithm needs data to learn from. Supervised learning refers to the task of inducing a learning function from a set of labeled examples so the function can map between the input (input variable(s)) and the output (output variable(s)) in the training examples. After training, the created model should be able to generalize and correctly predict an output for unseen datapoints.

One of the challenges when applying machine learning models to real applications is the need to ensure that the learned function or model is in agreement with one or more known application domain properties, such as one or more monotonic-type properties or relationships with respect to certain inputs. Capturing such relationships during training of the machine learning model is advantageous, and often necessary for operational feasibility of the model.

By way of example, a monotonic-type property might relate to one or more attributes associated with a particular application. For instance, where a value of an attribute increases, such as computing system performance, then everything else being equal in a multi-system environment, demand should increase for the higher performing system. Similarly, where system performance decreases, then demand should decrease for the lower performing system.

While being powerful and flexible at uncovering complex latent relationships, deep neural networks (DNNs), which are often complex, heavily engineered, opaque systems, can fail to generalize a known application domain property or relationship correctly using available labeled training data, leading to suboptimal model predictions. One approach to addressing this is to utilize simpler models cable of capturing monotonicity. Unfortunately, this can result in a loss of prediction accuracy (such as constraining the sign of a coefficient for a linear model). In another, model-specific approach, monotonicity can be configured into particular DNNs with a specific network structure. However, such model-specific approaches can be restrictive, complex to implement and also perform poorly empirically. Thus, to ensure that an application domain property, such as a monotonic relationship, is correctly captured, certain applications in practice have had to fall back to simpler and less accurate models (e.g., linear models), where such attributes or constraints can be more readily incorporated.

Advantageously, disclosed herein is a machine learning model-agnostic approach to augmenting a training data set to encourage inclusion of a desired application domain property, such as one or more monotonic-type properties or relationships, in predictions of the trained model. In one or more embodiments, unlabeled counterfactual data is leveraged by assigning or imputing where possible labels to the counterfactual data that are known to obey (for instance) the desired monotonicity, and to add these imputed counterfactual data points to the existing training data set. (Note that as used herein, imputing refers to assigning or ascribing by inference a value or label.) This augmentation approach can be used in a variety of applications, including, for instance, as data preprocessing, or be integrated into a self-training procedure for counterfactual inference, such as described herein. Prior to describing such machine learning model-agnostic approaches further, machine learning is further discussed below in the context of the embodiments of FIGS. 1 & 2, by way of example only.

FIG. 1 depicts one embodiment of a system 100, illustrating certain aspects of an embodiment of the present invention. System 100 includes one or more computing resources 110 that execute program code 112 that implements a cognitive engine 114, which includes one or more machine learning agents 116, and one or more machine learning models 118. Data 120, such as one or more datasets, are used by cognitive engine 114, to train model(s) 118, to generate one or more solutions, recommendations, actions 130, etc., based on the particular application of the machine learning model. In implementation, system 100 can include, or utilize, one or more networks for interfacing various aspects of computing resource(s) 110, as well as one or more data sources providing data 120, and one or more systems receiving the output solution, recommendation, action, etc., 130 of machine learning model(s) 118. By way of example, the network can be, for instance, a telecommunications network, a local-area network (LAN), a wide-area network (WAN), such as the Internet, or a combination thereof, and can include wired, wireless, fiber-optic connections, etc. The network(s) can include one or more wired and/or wireless networks that are capable of receiving and transmitting data, including training datasets for the machine learning model, and an output solution, recommendation, action, of the machine learning model, such as discussed herein.

In one or more implementations, computing resource(s) 110 houses and/or executes program code 112 configured to perform methods in accordance with one or more aspects of the present invention. By way of example, computing resource(s) 110 can be a server or other computing-system-implemented resource(s). Further, for illustrative purposes only, computing resource(s) 110 in FIG. 1 is depicted as being a single computing resource. This is a non-limiting example of an implementation. In one or more other implementations, computing resource(s) 110, by which one or more aspects of machine learning processing such as discussed herein can be implemented, could, at least in part, be implemented in multiple separate computing resources or systems, such as one or more computing resources of a cloud-hosting environment, by way of example.

Briefly described, in one embodiment, computing resource(s) 110 can include one or more processors, for instance, central processing units (CPUs). Also, the processor(s) can include functional components used in the integration of program code, such as functional components to fetch program code from locations, such as cache or main memory, decode program code, and execute program code, access memory for instruction execution, and write results of the executed instructions or code. The processor(s) can also include a register(s) to be used by one or more of the functional components. In one or more embodiments, the computing resource(s) can include memory, input/output, a network interface, and storage, which can include and/or access, one or more other computing resources and/or databases, as required to implement the machine learning processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). Examples of a computing resource(s) or a computer system(s) which can implement one or more aspects disclosed herein are described further below with reference to FIGS. 8-11.

As noted, program code 112 executes, in one implementation, a cognitive engine 114 which includes one or more machine learning agents 116 that facilitate training one or more machine learning models 118. The machine learning models are trained using one or more training datasets that can include a variety of types of data, depending on the model and the data sources. In one or more embodiments, program code 112 executing on one or more computing resources 110 applies machine learning algorithms of machine learning agent 116 to generate and train the model(s), which the program code then utilizes to make a prediction, perform a skill (e.g., provide a solution, make a recommendation, perform an action, etc.). In an initialization or learning stage, program code 112 trains one or more machine learning models 118 using a received or obtained training dataset that can include, in one or more embodiments, labeled factual data and unlabeled counterfactual data, such as described herein.

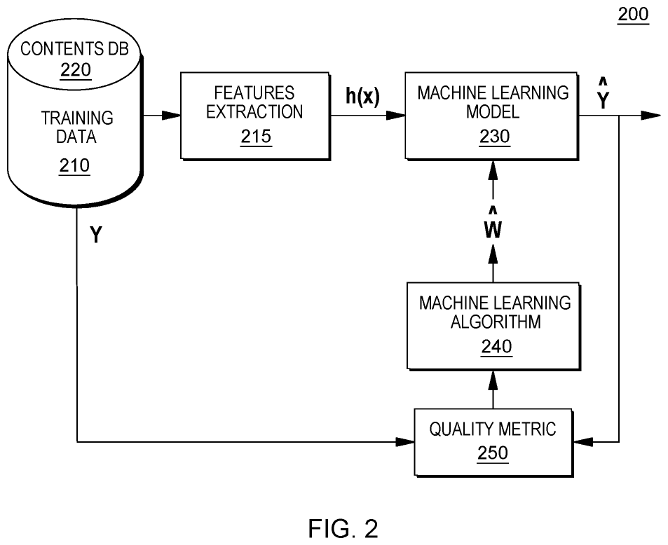

FIG. 2 is an example machine learning training system 200 that can be utilized to perform machine learning, such as described herein. Training data or dataset 210 used to train the model (in embodiments of the present invention) can include a variety of types of data, such as data generated by one or more devices or computer systems in communication with the computing resource(s) 110. Program code, in embodiments of the present invention, can perform machine learning analysis to generate data structures, including algorithms utilized by the program code to perform a machine learning skill, function, action, etc. As known, machine learning (ML) solves problems that cannot be solved by numerical means alone. In this ML-based example, program code extracts features/attributes from training data 210, which can be stored in memory or one or more databases 220. The extracted features 215 are utilized to develop a predictor function, h(x), also referred to as a hypothesis, which the program code utilizes as a machine learning model 230. In identifying machine learning model 230, various techniques can be used to select features (elements, patterns, attributes, etc.), including but not limited to, diffusion mapping, principle component analysis, recursive feature elimination (a brute force approach to selecting features), and/or a random forest, etc., to select the attributes related to the particular model. Program code can utilize a machine learning algorithm 240 to train machine learning model 230 (e.g., the algorithms utilized by program code), including providing weights for conclusions, so that the program code can train any predictor or performance function included in the machine learning model 240. The conclusions can be evaluated by a quality metric 250. By selecting an appropriate (e.g., a diverse) set of training data 210, the program code trains the machine learning model 240 to identify and weight various attributes (e.g., features, patterns) that correlate to enhanced performance of the machine-learned model.

Some embodiments of the present invention can utilize IBM Watson® as learning agent. IBM Watson® is a registered trademark of International Business Machines Corporation, Armonk, N.Y., USA. In embodiments of the present invention, the respective program code can interface with IBM Watson® application program interfaces (APIs) to perform machine learning analysis of obtained data. In some embodiments of the present invention, the respective program code can interface with the application programming interfaces (APIs) that are part of a known machine learning agent, such as the IBM Watson® application programming interface (API), a product of International Business Machines Corporation, to determine impacts of data on the machine learning model, and to update the model, accordingly.

In some embodiments of the present invention, certain of the APIs of the IBM Watson® API include a machine learning agent (e.g., learning agent) that includes one or more programs, including, but not limited to, natural language classifiers, Retrieve-and-Rank (i.e., a service available through the IBM Watson® developer cloud that can surface the most relevant information from a collection of documents), concepts/visualization insights, tradeoff analytics, document conversion, natural language processing, and/or relationship extraction. In an embodiment of the present invention, one or more programs can be provided to analyze data obtained by the program code across various sources utilizing one or more of, for instance, a natural language classifier, Retrieve-and-Rank APIs, and tradeoff analytics APIs.

In some embodiments of the present invention, the program code utilizes a neural network to analyze training data and/or collected data to generate an operational model or machine learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing complex datasets, neural networks and deep learning provide solutions to many problems in multi-source processing, which program code, in embodiments of the present invention, can utilize in implementing a machine learning model, such as described herein.

Embodiments of the present invention include computer program products, computer systems, and computer-implemented methods, where program code executing on one or more processors performs a method, which includes obtaining training data for use in training a machine learning model, where the training data includes factual data related to a particular application, and obtaining, with reference to the training data, unlabeled counterfactual data for the particular application. The method further includes imputing one or more labels to the unlabeled counterfactual data using domain knowledge for the particular application, to obtain imputed counterfactual data, where the domain knowledge includes one or more application domain properties. Further, the method includes training the machine learning model using the training data and the imputed counterfactual data to facilitate generating machine learning model predictions for the particular application in accordance with the one or more application domain properties.

In one embodiment, the imputing of one or more labels to the unlabeled counterfactual data using the domain knowledge, and the training of the machine learning model using, in part, the imputed counterfactual data, facilitates integrating one or more monotonic-type application domain properties into the machine learning model.

In one or more implementations, the method further includes providing the trained machine learning model to an artificial intelligence explainability model to generate explanations for the imputed one or more labels to the unlabeled counterfactual data, and receiving an evaluation of the imputing obtained by checking the generated explanations for the imputing of the one or more labels to confirm presence of the one or more application domain properties.

In one embodiment, the method further includes using the trained machine learning model to provide a prediction for the particular application in accordance with the one or more monotonic-type application domain properties.

In one or more implementations, the training of the machine learning model using the training data and the imputed counterfactual data includes training the machine learning model using the training data, and updating the machine learning model using the imputed counterfactual data. In one embodiment, the method further includes iteratively re-imputing one or more labels to the counterfactual data, and updating the machine learning model using the re-imputed label(s) until convergence. In one or more embodiments, the updating the machine learning model using the imputed counterfactual data facilitates reducing prediction error of the machine learning model contrary to the one or more integrated monotonic-type application domain properties.

In one embodiment, the trained machine learning model simulates a randomized control trial in agreement with the one or more monotonic-type properties. Further, in one or more embodiments, the trained machine learning model for the particular application includes discrete actions and discrete outcomes.

One or more embodiments disclosed herein relates to machine learning models or algorithms that employ one or more artificial intelligence (AI) models or algorithms. AI models can include a trained machine learning model (e.g., models, such as neural network (NN), a convolution neural network (CNN), a recurrent neural network (RNN), a long-short-term memory (LSTM) based neural network, a gate recurrent unit (GRU) based recurrent neural network, a tree-based convolution neural network, a K-nearest neighbor (KNN) as a neural network, a self-attention network (e.g., a neural network that utilizes the attention mechanism as a basic building block; where self-attention networks have been shown to be effective for sequence modeling tasks, while having no recurrence or convolutions), a bi-directional long-short-term memory (BiLSTM), etc.). As known, an artificial neural network is an interconnected group of nodes or neurons.

One approach to machine learning is to learn an offline machine learning algorithm directly from observational data, and use the model for prediction. This is known as the “direct method”. The direct method functions typically without accounting for any inherent application domain property, such as one or more monotonic-type properties of a particular application. The direct method runs an online A/B test as a randomized trial that: requires carefully designed experiments and an interactive platform to support; can be costly (in terms of processing and memory) by lacking one or more application domain properties; the number of A/B tests is limited; and there is a relatively long turnaround time.

In accordance with one or more aspects disclosed herein, a model agnostic learning approach is disclosed to facilitate capturing one or more application domain attributes, such as one or more monotonicity properties. For instance, in one or more embodiments, a training dataset with labeled factual data and unlabeled counterfactual data can be augmented in a preprocessing step, where a known application domain property, such as a known monotonic-type property, can be used to impute labels for certain counterfactual data of the training dataset (based on the factual data available and the particular domain knowledge). In this way, the unlabeled counterfactual data can be leveraged by assigning labels to certain samples that are known to obey the desired attribute (e.g., monotonicity property), with the imputed counterfactual data being added to the training dataset used to train the model. In this manner, the attribute (e.g., monotonicity) can be encouraged in the learned function using the available application domain knowledge. The approach presented is flexible in that it can be used to train a variety of machine learning models, including, a direct method trained model. In addition to directly imputing certain counterfactual labels, other counterfactual labels can be further imputed by iteratively retraining the machine learning model or estimator, such as described in certain embodiments below.

In one or more embodiments, the counterfactual inference problem can be framed as a domain adaption problem, where the search domain is the factual data (i.e., observational data), and the target domain is a randomized trial on the same feature distribution. In one embodiment, a randomized trial is explicitly simulated by imputing labels (pseudo-labels) for the counterfactuals (e.g., the unobserved actions). The optimization process can be performed, in one embodiment, by directly imputing the pseudo-labels using one or more application domain properties and/or iteratively updating the pseudo-labels and using a machine learning model that is trained on both the factual and the counterfactual data with the desired property, or properties. This process can thus work in a preprocessing approach, and work in a self-supervised approach, referred to herein as a counterfactual self-training approach. With both imputing approaches, the one or more application domain properties are advantageously integrated into the machine learning model training.

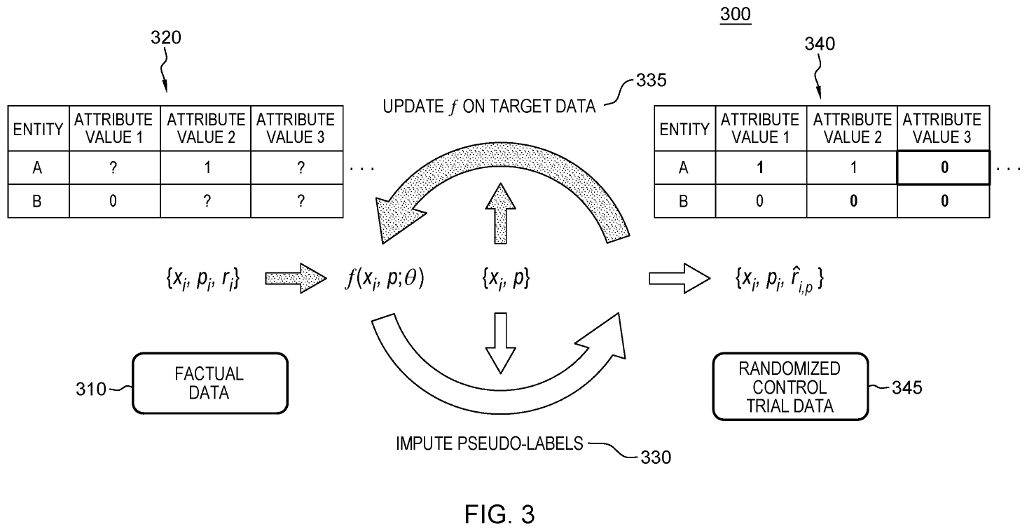

For instance, in one or more aspects, in a self-supervised approach, rather than training a machine learning model (such as a raw classifier), with only existing factual data (i.e., observational data), unlabeled data can also be leveraged. For example, one or more known monotonic-type application domain properties of a particular application can be used to impute labels for certain counterfactual data obtained with reference to the training data set. FIG. 3 illustrates one embodiment of such a process 300 of augmenting factual (i.e., observational) data 310 and updating a machine learning model by iteratively training on both factual data and imputed counterfactual data, according to one embodiment.

In one example embodiment, assume that there are 2 factual data in a data structure 320 where, for instance, entity A obtain or used a computing system with an attribute having value 2, denoted by “1” in the data structure, and entity B did not obtain or use a computing system with an attribute value 1 (denoted by “0”) in the data structure 320. The question marks in data structure 320 represent counterfactual outcomes, for which no factual data currently exists. For these unseen, counterfactual outcomes, pseudo-labels 330 can be imputed (either directly for certain outcomes, or indirectly, such as by a machine learning model), and then used to augment the factual data as part of the data used to update the machine learning model, or function. Depending on the implementation, for certain counterfactual outcomes, or even all counterfactual outcomes, pseudo-labels can be inserted into the revised training data structure 340, such as illustrated in FIG. 3 (where the question marks in data structure 320 are replaced with counterfactual outcomes in data structure 340). Note that in one or more embodiments, the pseudo-labels are imputed by a machine learning model, and then used to augment the factual data 310. The machine learning model or function is trained, or updated, by training on both the factual data 310 and the imputed counterfactual data 330. In one embodiment, this iterative training procedure continues until it converges to randomized control trial data 345. For instance, in one or more embodiments, imputing labels to counterfactual data such as disclosed herein can be integrated into a counterfactual self-training framework, where the goal is to generate pseudo-labels for the counterfactuals such that the final dataset (factual+counterfactual) resembles a simulated, randomized trial. By doing so, it is also possible to remove any bias in a historical policy (which may over-represent or under-represent certain actions).

A variety of application domain properties, such as one or more monotonic-type properties, can be used to assign or impute labels, or pseudo-labels, to counterfactual data in the training data. For instance, where attribute value 1 is larger than attribute value 2, which is larger than attribute value 3, then, in the computing performance example, with entity A selecting the system with attribute value 2 performance, it can be imputed that all else being equal, entity A would also select the system with attribute value 1 performance. Similarly, since entity B did not select the system with attribute value 1 performance, it can be imputed that, all else being equal, entity B would not select the systems with attribute value 2 performance, or attribute value 3 performance. Thus, because of domain knowledge in the form of monotonicity of the demand function, labels for the unlabeled, counterfactual data can be assigned or imputed. As a result, instead of simply having two factual data samples, five factual data samples (for instance) are available as augmentation to train a machine learning model, such as a classifier. This can be a direct imputation process using the domain knowledge. The remaining unlabeled counterfactual data, that is, what would happen if entity A were presented with attribute value 3 performance, can further be obtained by iteratively retraining the estimator f(x,p,θ), or machine learning model.

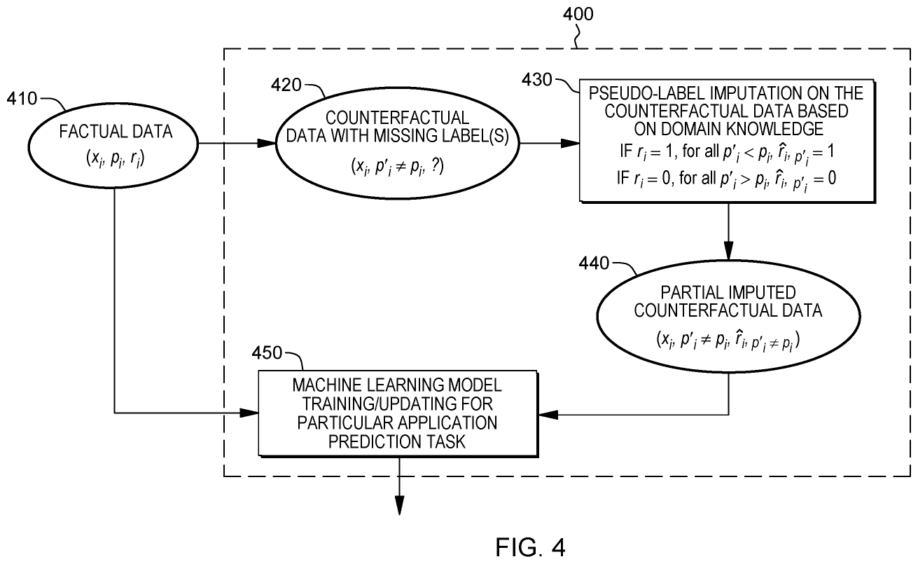

As noted, in one embodiment, the data augmentation described herein, based on prior domain knowledge, can be implemented as a preprocessing step, one embodiment of which is depicted in FIG. 4. In one embodiment, the machine learning model process 400 can be viewed as an extension via domain adaptation of the direct method. As illustrated, factual data 410, which can include ‘i’ observed datapoints, where the symbol ‘x’ represents an abstract space, and ‘p’ is the discrete action space that an agent can select for each sample, after which an outcome or reward ‘r’ is revealed to the agent. For instance, in precision medicine, x, p, and r can represent a patient cohort, feasible treatment for disease, and an indicator of outcome after the treatment. In one embodiment, the process 400 obtains counterfactual data with missing labels 420, where p′ᵢ≠pᵢ represents a discrete counterfactual action space, and ‘?’ represents an unlabeled outcome. The domain knowledge processing assigns or imputes labels, or pseudo-labels, to certain counterfactual data based on domain knowledge, that is, based on one or more known application domain properties, or rules, such as a monotonic-type application domain property 430. In the example embodiment, if rᵢ=1, then for all p′ᵢ<pᵢ, the imputed label \hat{r}ᵢ, p′ᵢ=1, for a monotonically decreasing case (with the signs are to be reversed for a monotonically increasing case). Similarly, for rᵢ=0, then for all p′ᵢ>pᵢ, \hat{r}ᵢ, p′₁=0 for the imputed label. This process produces (in the example embodiment) partially imputed counterfactual data 440 (xᵢ, p′ᵢ≠pᵢ). The machine learning model can then be trained or updated for the particular application prediction task 450 using both the factual data 410 and the imputed counterfactual data 440 to provide a trained machine learning model which, for instance, generates more accurate predictions for the particular application, that is, predictions that are in accordance with the one or more application domain properties integrated via the imputed counterfactual data.

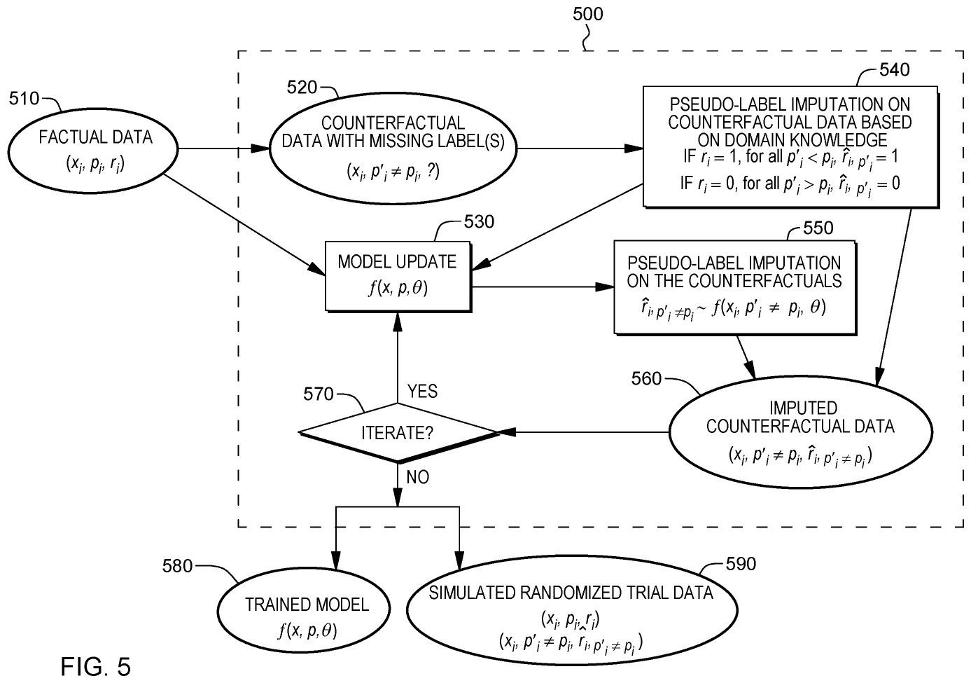

In a further embodiment, data augmentation such as described herein, based on prior domain knowledge, can be implemented in combination with a counterfactual self-training process such as discussed above in connection with FIG. 3, and further below with respect to FIG. 5.

Referring to FIG. 5, in one embodiment, machine learning model training 500 includes both a pseudo-labeled imputation on some counterfactual data based on domain knowledge 540, as well as an iterative self-training of the machine learning model via pseudo-label imputation on certain other counterfactuals 550. As in the embodiment of FIG. 4, factual data 510 is obtained (e.g., received, accessed, etc.), which again can include ‘i’ observed datapoints, where the symbol ‘x’ represents an abstract space, and is the discrete action space that an agent can select for each sample, after which an outcome or reward ‘r’ is revealed to the agent. Factual data 510 can be part of a training dataset, and with reference to the factual data, counterfactual data with missing labels can be obtained 520, where p′ᵢ≠pᵢ represents a discrete counterfactual action space, and ‘?’ represents an unlabeled outcome. Domain knowledge processing assigns or imputes labels, or pseudo-labels, to counterfactual data where possible based on domain knowledge, that is, based on one or more knowledge application domain properties, or rules, such as a monotonic-type application domain property 540. As illustrated, the example embodiment is similar to that depicted and described above in connection with FIG. 4. This process produces, at least in part, imputed counterfactual data 560 (xᵢ, p′ᵢ≠pᵢ, \hat{r}_{i,p′i≠pi}). The machine learning model further self-trains or updates for the particular application prediction task 530 using both factual data 510 and the imputed counterfactual data 540/560 in an iterating 570 loop to self-train or input pseudo-labels on the counterfactuals.

Note in this regard that the pseudo-label imputation on counterfactual data based on domain knowledge is in combination with counterfactual self-training processing 530/550 to achieve the set of imputed counterfactual data 560 in the embodiment of FIG. 5.

Self-training has been used in unsupervised domain adaptation (UDA) and semi-supervised learning (SSL), and has achieved success. The self-training algorithm works in an iterative fashion: first, after training a classifier f (x, p) on a source dataset, pseudo-labels are created by the best guess of f, along with the imputed labels based on application domain knowledge. Next, the model is trained on a target dataset, and the trained model is used to generate new pseudo-labels. This is illustrated in FIG. 5. To formulate the counterfactual learning problem as a domain adaptation problem, observational data is viewed as data sampled from a source distribution D_{S}= [symbol] (x)π(p|x), where x represents an abstract space and [symbol] (x) is a probability distribution on x. The target domain is a randomized trial on the same feature distribution to ensure a uniformly good approximation on all actions. The goal is to transfer observational data from the source domain to a simulated pseudorandomized trial via self-training. To accomplish this, first an initial classifier f₀(x, p) is trained on observational data, then pseudo-labels are imputed on all unseen actions from the observation data (and the imputing based on domain knowledge) with \hat{r}_{i,p}˜f(xᵢ, p). The model is then updated by training with the following objective:

$${min}_{θ} {ℒ}_{S T} = \frac{1}{N \vert P \vert} ( {\underbrace{{\sum }_{i = 1}^{N} l ( {f}_{θ} ( {x}_{i} , {p}_{i} ) , {r}_{i} )}}_{{ℒ}_{src}} + {\sum }_{i = 1}^{N} {\sum }_{p ∈ P ∖ {p}_{i}} l ( {f}_{θ} ( {x}_{i} , p ) , {\hat{r}}_{i , p} ) ) \qquad ( Eq . 1 )$$

In one embodiment, the first term [symbol] _{src} in Eq. 1 corresponds to the loss used in direct method, defined over the factual data alone. The second term refers to the loss defined over the imputed counterfactual data. In other words, in order to obtain a good model across all actions, the pseudo-population induced from imputation that represents a simulated randomized trial is utilized. The model is iteratively trained and pseudo-labels are imputed until the model converges.

As noted, in one embodiment, the iterative training is further with reference to pseudo-labeled counterfactual data based on domain knowledge 540. For instance, where an imputed label by the self-training agrees with the domain knowledge imputed label, it is retained, whereas if not, then it is re-imputed in a next iteration of the model update until the model converges.

In one embodiment, the output from the model update 530 is the pseudo-label imputation on counterfactuals

$$( {\hat{r}}_{i , {p}_{i \neq {p}_{i}}^{′}} ∼ f ( {x}_{i} , {p}_{i}^{′} \neq {p}_{i} , θ ) ) 550 ,$$

which provides the imputed counterfactual data

$$( {x}_{i} , {p}_{i}^{′} \neq {p}_{i} , {\hat{r}}_{i , {p}_{i \neq {p}_{i}}^{′}} ) 560 .$$

In block 570, as long as the iteration is valid, the process proceeds to again update the model 530. Otherwise, the process proceeds to the learnt function processing (f (x, p, θ)) 580 and the simulated randomized trial processing

$$( ( {x}_{i} , {p}_{i} , {r}_{i} ) , ( {x}_{i} , {p}_{i}^{′} \neq {p}_{i} , {\hat{r}}_{i , {p}_{i \neq {p}_{i}}^{′}} ) ) 590.$$

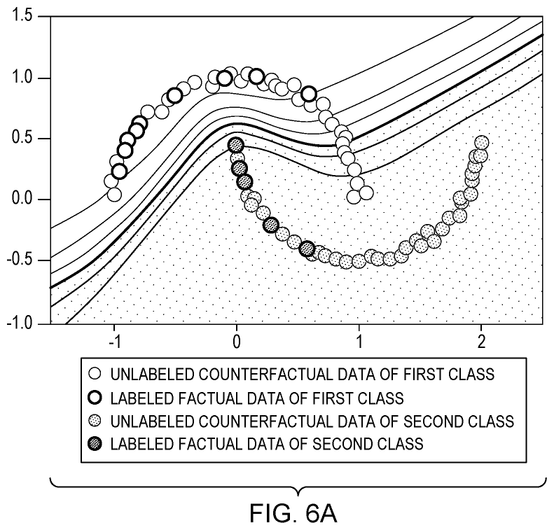

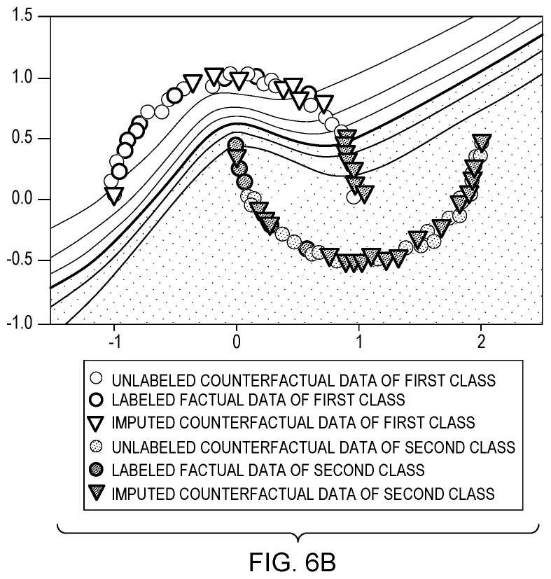

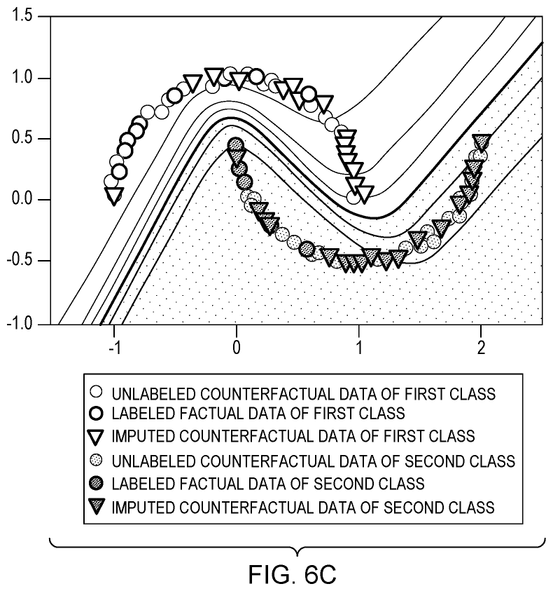

By way of example, FIG. 6A illustrates a graph of a machine learning model process trained on factual data alone, according to an embodiment. In the example embodiment, the model is being trained to classify two different classes of data, that is, a first class of data and a second class of data. The solid circles represent factual data, the translucent circles represent unlabeled counterfactual data, and the triangles represent imputed counterfactual data. FIG. 6B illustrates a graph showing results after a first imputation with the machine learning model process, according to an embodiment. Note in this regard that, with only a single self-training imputation, certain imputed counterfactual data of the second class of data is wrongly assigned. FIG. 6C illustrates a graph showing results upon convergence with the machine learning model process, according to an embodiment. The procedure is shown to work by assuming the enforced monotonicity pattern is consistent with the underlying truth. It can be shown that, with the discussed data imputation, the loss function on the augmented data upper-bounds the loss on the original data, with a regularization term corresponding to violations of monotonicity. Empirical evidence suggests that the data augmentation described herein better utilizes the underlying data structure, and refines the decision boundary through extrapolation between actions. Advantageously, by combining imputing of labels on counterfactual data based on domain knowledge, such as described herein, the self-training process is able to converge much more quickly on the final imputed counterfactual data for the dataset.

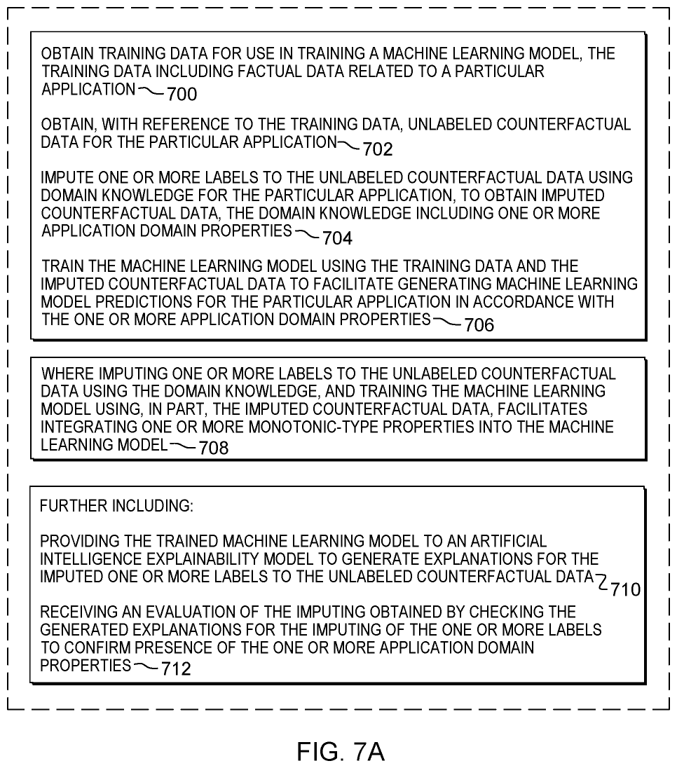

Further details of one embodiment of facilitating processing within a computing environment, as it relates to one or more aspects of the present invention, are described with reference to FIGS. 7A-7B.

Referring to FIG. 7A, in one embodiment, the method includes obtaining training data for use in training a machine learning model, where the training data includes factual data related to a particular application 700, and obtaining, with reference to the training data, unlabeled counterfactual data for the particular application 702. One or more labels are imputed to the unlabeled counterfactual data using domain knowledge for the particular application, to obtain imputed counterfactual data, where the domain knowledge includes one or more application domain properties 704. The machine learning model is trained using the training data and the imputed counterfactual data to facilitate generating machine learning model predictions for the particular application in accordance with the one or more application domain properties 706.

In one embodiment, imputing one or more labels to the unlabeled counterfactual data using the domain knowledge, and training the machine learning model using, in part, the imputed counterfactual data, facilitates integrating one or more monotonic-type properties into the machine learning model 708.

In one embodiment, the method further includes providing the trained machine learning model to an artificial intelligence explainability model to generate explanations for the imputed one or more labels to the unlabeled counterfactual data 710, and receiving an evaluation of the imputing obtained by checking the generated explanations for the imputing of the one or more labels to confirm presence of one or more application domain properties 712.

As illustrated in FIG. 7B, in another example, the method further includes using the trained machine learning model to provide a prediction for the particular application in accordance with the one or more monotonic-type properties 714.

In one embodiment, training the machine learning model using the training data and the imputed counterfactual data includes training the machine learning model using the training data 716, and updating the machine learning model using the imputed counterfactual data 718.

In one or more implementations, the method further includes iteratively re-imputing one or more labels to the counterfactual data 720, and updating the machine learning model using the re-imputed label(s) until convergence 722.

In one embodiment, the updating of the machine learning model using the imputed counterfactual data facilitates reducing any prediction error of the machine learning model contrary to the one or more monotonic-type properties 724.

In one embodiment, the trained machine learning model simulates a randomized control trial in agreement with the one or more monotonic-type properties 726. In one or more implementations, the trained machine learning model for the particular application includes discrete actions and discrete outcomes 728.

Other variations and embodiments are possible.

Imputing counterfactual data (in association with machine learning model training) in accordance with one or more aspects of the present invention can be incorporated and used in many computing environments. One example computing environment is described with reference to FIG. 8. As an example, the computing environment is based on the z/Architecture® hardware architecture, offered by International Business Machines Corporation, Armonk, N.Y. The z/Architecture hardware architecture, however, is only one example architecture. The computing environment can also be based on other architectures, including, but not limited to, the Intel ×86 architectures, other architectures of International Business Machines Corporation, and/or architectures of other companies.

As shown in FIG. 8, a computing environment 800 includes, for instance, a computer system 802 shown, e.g., in the form of a general-purpose computing device. Computer system 802 can include, but is not limited to, one or more processors or processing units 804 (e.g., central processing units (CPUs)), a memory 806 (a.k.a., system memory, main memory, main storage, central storage or storage, as examples), and one or more input/output (I/O) interfaces 808, coupled to one another via one or more buses and/or other connections. For instance, processors 804, and memory 806, are coupled to I/O interfaces 808 via one or more buses 810, and processors 804 are coupled to one another via one or more buses 811.

Bus 811 is, for instance, a memory or a cache coherence bus, and bus 810 represents, e.g., one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

As examples, one or more special purpose processors (e.g., adjunct processors) can be separate from but coupled to one or more general purpose processors and/or can be embedded within one or more general purpose processors. May variations are possible.

Memory 806 can include, for instance, a cache 812, such as a shared cache, which may be coupled to local caches 814 of processors 804 via, for instance, one or more buses 810. Further, memory 806 can include one or more programs or applications 816, at least one operating system 818, one or more computer readable program instructions 820 and one or more machine learning agents 822 training one or more machine learning models 821. Computer readable program instructions 820 and/or machine learning agent(s) 822 can be configured to carry out, or facilitate, functions of embodiments of aspects of the invention.

Computer system 802 can communicate via, e.g., I/O interfaces 808 with one or more external devices 830, such as a user terminal, a tape drive, a pointing device, a display, and one or more data storage devices 834, etc. A data storage device 834 can store one or more programs 836, one or more computer readable program instructions 838, and/or data, etc. The computer readable program instructions can be configured to carry out functions of embodiments of aspects of the invention.

Computer system 802 can also communicate via, e.g., I/O interfaces 808 with a network interface 832, which enables computer system 802 to communicate with one or more networks, such as a local area network (LAN), a general wide area network (WAN), and/or a public network (e.g., the Internet), providing communication with other computing devices or systems.

Computer system 802 can include and/or be coupled to removable/non-removable, volatile/non-volatile computer system storage media. For example, it can include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with computer system 802. Examples, include, but are not limited to: microcode, device drivers, redundant processing units, external disk drive arrays, RAID systems, tape drives, and data archival storage systems, etc.

Computer system 802 can be operational with numerous other general-purpose or special purpose computing system environments or configurations. Examples of well-known computing systems, environments, and/or configurations that may be suitable for use with computer system 802 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

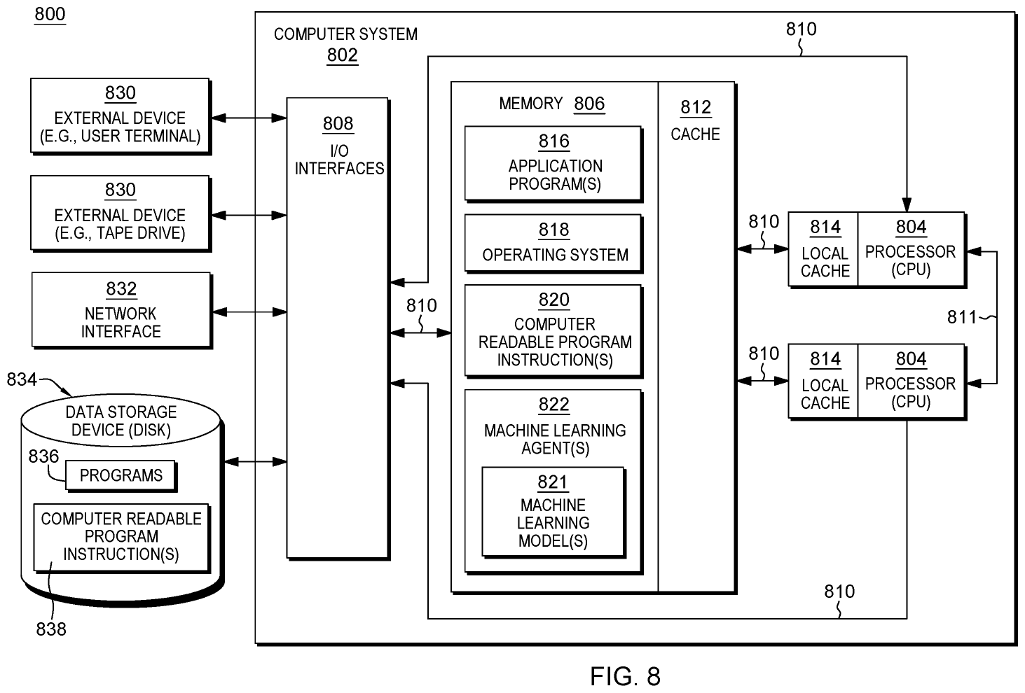

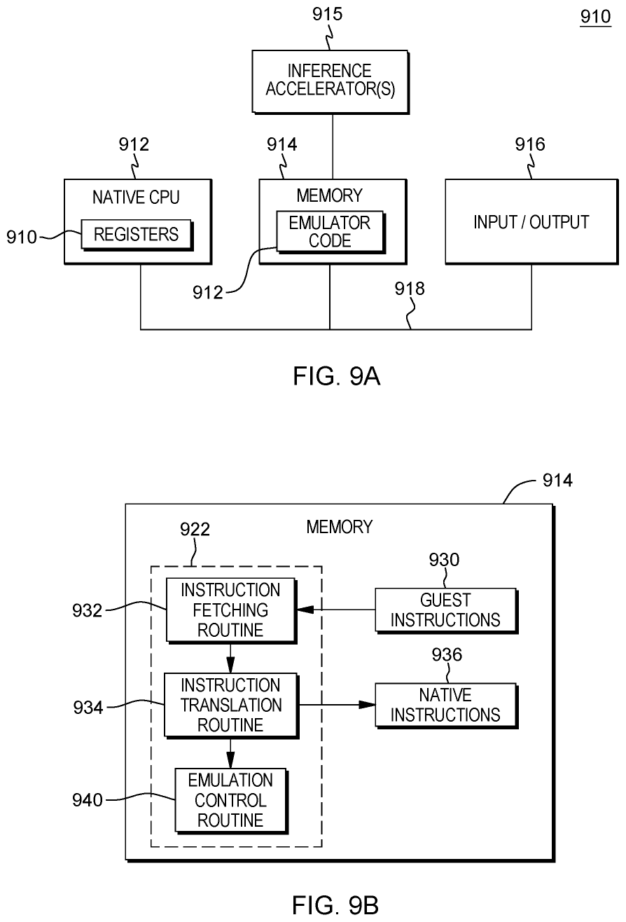

Another embodiment of a computing environment which can incorporate and use one or more aspects of the present invention is described with reference to FIG. 9A. In this example, a computing environment 900 includes, for instance, a native central processing unit (CPU) 912, a memory 914, and one or more input/output devices and/or interfaces 916 coupled to one another via, for example, one or more buses 918 and/or other connections. As examples, computing environment 910 may include a PowerPC® processor offered by International Business Machines Corporation, Armonk, N.Y.; an HP Superdome with Intel Itanium II processors offered by Hewlett Packard Co., Palo Alto, Calif.; and/or other machines based on architectures offered by International Business Machines Corporation, Hewlett Packard, Intel Corporation, Oracle, or others. PowerPC is a trademark or registered trademark of International Business Machines Corporation in at least one jurisdiction. Intel and Itanium are trademarks or registered trademarks of Intel Corporation or its subsidiaries in the United States and other countries.

Native central processing unit 912 includes one or more native registers 920, such as one or more general purpose registers and/or one or more special purpose registers used during processing within the environment. These registers include information that represents the state of the environment at any particular point in time.

Moreover, native central processing unit 912 executes instructions and code that are stored in memory 914. In one particular example, the central processing unit executes emulator code 922 stored in memory 914. This code enables the computing environment configured in one architecture to emulate another architecture. For instance, emulator code 922 allows machines based on architectures other than the z/Architecture hardware architecture, such as PowerPC processors, HP Superdome servers or others, to emulate the z/Architecture hardware architecture and to execute software and instructions developed based on the z/Architecture hardware architecture.

Further details relating to emulator code 922 are described with reference to FIG. 9B. Guest instructions 930 stored in memory 914 comprise software instructions (e.g., correlating to machine instructions) that were developed to be executed in an architecture other than that of native CPU 912. For example, guest instructions 930 may have been designed to execute on a processor based on the z/Architecture hardware architecture, but instead, are being emulated on native CPU 912, which may be, for example, an Intel Itanium II processor. In one example, emulator code 922 includes an instruction fetching routine 932 to obtain one or more guest instructions 930 from memory 914, and to optionally provide local buffering for the instructions obtained. It also includes an instruction translation routine 934 to determine the type of guest instruction that has been obtained and to translate the guest instruction into one or more corresponding native instructions 936. This translation includes, for instance, identifying the function to be performed by the guest instruction and choosing the native instruction(s) to perform that function.

Further, emulator code 922 includes an emulation control routine 940 to cause the native instructions to be executed. Emulation control routine 940 may cause native CPU 912 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 936 may include loading data into a register from memory 914; storing data back to memory from a register; or performing some type of arithmetic or logic operation, as determined by the translation routine.

Each routine is, for instance, implemented in software, which is stored in memory and executed by native central processing unit 912. In other examples, one or more of the routines or operations are implemented in firmware, hardware, software or some combination thereof. The registers of the emulated processor may be emulated using registers 920 of the native CPU or by using locations in memory 914. In embodiments, guest instructions 930, native instructions 936 and emulator code 922 may reside in the same memory or may be disbursed among different memory devices.

Further, in one embodiment, computing environment 910 includes one or more inference accelerators 915 coupled to memory 914. The one or more accelerators are defined in one architecture and are configured to emulate another architecture. For example, an accelerator obtains guest commands of the architecture being emulated, translates the guest commands into native commands of the one architecture and executes the native commands.

The computing environments described above are only examples of computing environments that can be used. Other environments, including but not limited to, non-partitioned environments, partitioned environments, cloud environments and/or emulated environments, may be used; embodiments are not limited to any one environment. Although various examples of computing environments are described herein, one or more aspects of the present invention may be used with many types of environments. The computing environments provided herein are only examples.

Each computing environment is capable of being configured to include one or more aspects of the present invention. For instance, each may be configured for an inference acceleration facility, in accordance with one or more aspects of the present invention.

Although various embodiments are described herein, many variations and other embodiments are possible without departing from a spirit of aspects of the present invention. It should be noted that, unless otherwise inconsistent, each aspect or feature described herein, and variants thereof, may be combinable with any other aspect or feature.

One or more aspects may relate to cloud computing.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

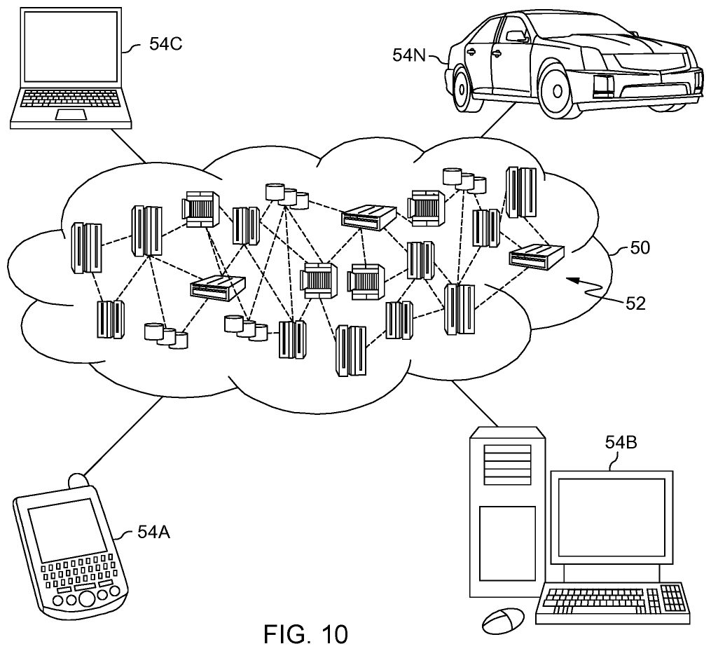

Referring now to FIG. 10, illustrative cloud computing environment 50 is depicted. As shown, cloud computing environment 50 includes one or more cloud computing nodes 52 with which local computing devices used by cloud consumers, such as, for example, personal digital assistant (PDA) or cellular telephone 54A, desktop computer 54B, laptop computer 54C, and/or automobile computer system 54N may communicate. Nodes 52 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 10 are intended to be illustrative only and that computing nodes 52 and cloud computing environment 50 can communicate with any type of computerized device over any type of network and/or network addressable connection (e.g., using a web browser).

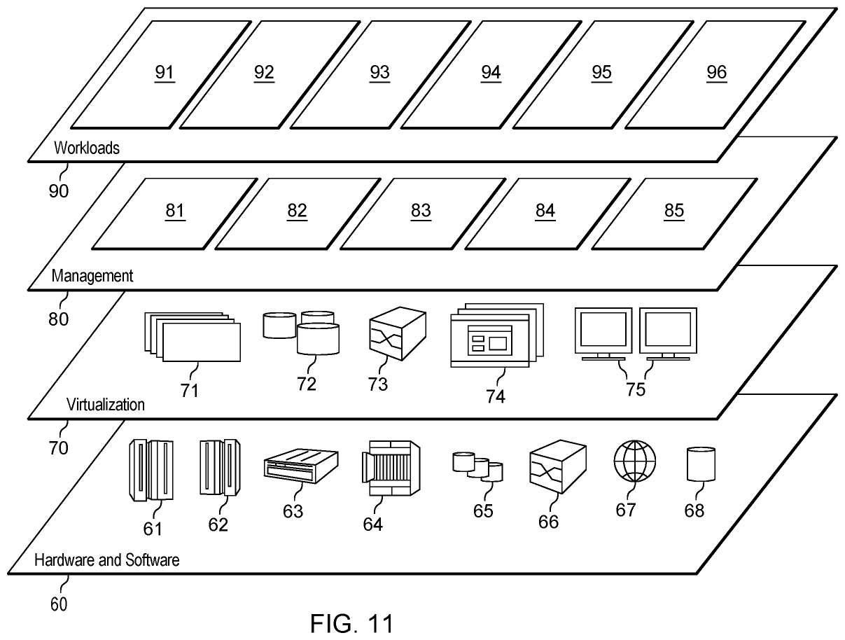

Referring now to FIG. 11, a set of functional abstraction layers provided by cloud computing environment 50 (FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and imputing counterfactual data in association with machine learning model training processing 96, such as disclosed herein.

Aspects of the present invention can be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, computing environments of other architectures can be used to incorporate and use one or more embodiments. Further, different instructions, commands or operations may be used. Additionally, different types of indications or tags may be specified. Many variations are possible.

Various aspects are described herein. Further, many variations are possible without departing from a spirit of aspects of the present invention. It should be noted that, unless otherwise inconsistent, each aspect or feature described herein, and variants thereof, may be combinable with any other aspect or feature.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product for facilitating processing within a computing environment, the computer program product comprising:
one or more computer-readable storage media and program instructions embodied therewith, the program instructions being readable by a processing circuit to cause the processing circuit to perform a method comprising:
obtaining training data for use in training a machine learning model, the training data comprising factual data related to a particular application;
obtaining, with reference to the training data, unlabeled counterfactual data for the particular application;
imputing one or more labels to the unlabeled counterfactual data using domain knowledge for the particular application, to obtain imputed counterfactual data, the domain knowledge including one or more application domain properties; and
training the machine learning model using the training data and the imputed counterfactual data to facilitate generating machine learning model predictions for the particular application in accordance with the one or more application domain properties.

2. The computer program product of claim 1, wherein imputing one or more labels to the unlabeled counterfactual data using the domain knowledge, and training the machine learning model using, in part, the imputed counterfactual data, facilitates integrating one or more monotonic-type properties into the machine learning model.

3. The computer program product of claim 2, further comprising:
providing the trained machine learning model to an artificial intelligence explainability model to generate explanations for the imputed one or more labels to the unlabeled counterfactual data; and
receiving an evaluation of the imputing obtained by checking the generated explanations for the imputing of the one or more labels to confirm presence of the one or more application domain properties.

4. The computer program product of claim 2, further comprising using the trained machine learning model to provide a prediction for the particular application in accordance with the one or more monotonic-type properties.

5. The computer program product of claim 2, wherein training the machine learning model using the training data and the imputed counterfactual data comprises:
training the machine learning model using the training data; and
updating the machine learning model using the imputed counterfactual data.

6. The computer program product of claim 5, further comprising iteratively:
re-imputing one or more labels to the counterfactual data; and
updating the machine learning model using the re-imputed label(s) until convergence.

7. The computer program product of claim 5, wherein the updating of the machine learning model using the imputed counterfactual data facilitates reducing any prediction error of the machine learning model contrary to the one or more monotonic-type properties.

8. The computer program product of claim 2, wherein the trained machine learning model simulates a randomized control trial in agreement with the one or more monotonic-type properties.

9. The computer program product of claim 2, wherein the trained machine learning model for the particular application comprises discrete actions and discrete outcomes.

10. A computer system for facilitating processing within a computing environment, the computer system comprising:
a memory; and
at least one processor in communication with the memory, wherein the computer system is configured to perform a method, the method comprising:
obtaining training data for use in training a machine learning model, the training data comprising factual data related to a particular application;
obtaining, with reference to the training data, unlabeled counterfactual data for the particular application;
imputing one or more labels to the unlabeled counterfactual data using domain knowledge for the particular application, to obtain imputed counterfactual data, the domain knowledge including one or more application domain properties; and
training the machine learning model using the training data and the imputed counterfactual data to facilitate generating machine learning model predictions for the particular application in accordance with the one or more application domain properties.

11. The computer system of claim 10, wherein imputing one or more labels to the unlabeled counterfactual data using the domain knowledge, and training the machine learning model using, in part, the imputed counterfactual data, facilitates integrating one or more monotonic-type properties into the machine learning model.

12. The computer system of claim 11, wherein the method performed further comprises:
providing the trained machine learning model to an artificial intelligence explainability model to generate explanations for the imputed one or more labels to the unlabeled counterfactual data; and
receiving an evaluation of the imputing obtained by checking the generated explanations for the imputing of the one or more labels to confirm presence of the one or more application domain properties.

13. The computer system of claim 11, wherein training the machine learning model using the training data and the imputed counterfactual data comprises:
training the machine learning model using the training data; and
updating the machine learning model using the imputed counterfactual data.

14. The computer system of claim 13, wherein the method performed further comprises iteratively:
re-imputing one or more labels to the counterfactual data; and
updating the machine learning model using the re-imputed label(s) until convergence.

15. The computer system of claim 11, wherein the trained machine learning model simulates a randomized control trial in agreement with the one or more monotonic-type properties.

16. A computer-implemented method of facilitating processing within a computing environment, the computer-implemented method comprising:
obtaining training data for use in training a machine learning model, the training data comprising factual data related to a particular application;
obtaining, with reference to the training data, unlabeled counterfactual data for the particular application;
imputing one or more labels to the unlabeled counterfactual data using domain knowledge for the particular application, to obtain imputed counterfactual data, the domain knowledge including one or more application domain properties; and
training the machine learning model using the training data and the imputed counterfactual data to facilitate generating machine learning model predictions for the particular application in accordance with the one or more application domain properties.

17. The computer-implemented method of claim 16, wherein imputing one or more labels to the unlabeled counterfactual data using the domain knowledge, and training the machine learning model using, in part, the imputed counterfactual data, facilitates integrating one or more monotonic-type properties into the machine learning model.

18. The computer-implemented method of claim 17, further comprising:
providing the trained machine learning model to an artificial intelligence explainability model to generate explanations for the imputed one or more labels to the unlabeled counterfactual data; and
receiving an evaluation of the imputing obtained by checking the generated explanations for the imputing of the one or more labels to confirm presence of the one or more application domain properties.

19. The computer-implemented method of claim 17, wherein training the machine learning model using the training data and the imputed counterfactual data comprises:
training the machine learning model using the training data; and
updating the machine learning model using the imputed counterfactual data.

20. The computer-implemented method of claim 17, wherein the trained machine learning model simulates a randomized control trial in agreement with the one or more monotonic-type properties.
